(19) United States
(12) Patent Application Publication
(10) Pub. No.: US 2010/0179976 A1
(43) Pub. Date: Jul. 15, 2010

(54) SEMICONDUCTOR DEVICE PERFORMING OPERATIONAL PROCESSING

(75) Inventors: Masakatsu ISHIZAKI, Hiroshima (JP); Takeshi Kumaki, Hiroshima (JP); Masaharu Tagami, Hiroshima (JP); Yuta Imai, Hiroshima (JP); Tetsushi Koide, Hiroshima (JP); Hans Jürgen Mattausch, Hiroshima (JP); Takayuki Gyoten, Tokyo (JP); Hideyuki Noda, Tokyo (JP); Yoshihiro Okuno, Tokyo (JP); Kazutami Arimoto, Tokyo (JP)

Correspondence Address: MCDERMOTT WILL & EMERY LLP, 600 13TH STREET, N.W., WASHINGTON, DC, 20005-3096, US

(73) Assignees: RENESAS TECHNOLOGY CORP.; HIROSHIMA UNIVERSITY

(21) Appl. No.: 12/687,756

(22) Filed: Jan. 14, 2010

(30) Foreign Application Priority Data
Jan. 15, 2009 (JP) 2009-006947 (P)

(51) Int. Cl. G06F 7/44; G06F 5/01; G06F 7/552

(52) U.S. Cl. 708/209; 708/606; 708/603

(57) ABSTRACT

A semiconductor device includes a decoder receiving first multiplier data of 3 bits indicating a multiplier to output a shift flag, an inversion flag, and an operation flag in accordance with Booth's algorithm, and a first partial product calculation unit receiving first multiplicand data of 2 bits indicating a multiplicand, a shift flag, an inversion flag, and an operation flag to select one of the higher order bit and lower order bit of the first multiplicand data based on the shift flag, invert or non-invert the selected bit based on the inversion flag, select one of the inverted or non-inverted data and data of a predetermined logic level based on the operation flag, and output the selected data as partial product data indicating the partial product of the first multiplier data and the first multiplicand data.

### BACKGROUND OF THE INVENTION

1. Field of the Invention

The present invention relates to semiconductor devices, particularly a semiconductor device performing operational processing.

2. Description of the Background Art

In accordance with the widespread use of digital cameras, digital videos, video conferences, portable phones and the like these few years, the amount of data in multimedia applications for audio, still pictures, motion pictures and the like is increasing. It has also become necessary to process the increased amount of data in real time. Moreover, the need arises for mobile equipment that can perform not only high-speed processing, but also that can be driven for over a long period of time in view of its portability, in addition to a compact requirement. New standards such as WCDMA (Wideband Code Division Multiple Access),

JPEG (Joint Photographic Expert Group) 2000 and MPEG (Moving Picture Experts Group) have also emerged. In light of the aforementioned trend, the LSI for processing multimedia applications has to comply with the mandatory requirements of high-speed processing, low power consumption, and small area. Accordingly, digital signal processors (DSP) as well as ASIC (Application Specific Integrated Circuit) specialized in unique processing have been conventionally utilized.

Multimedia applications are generally characterized in that the mutual dependency between processing data is low, allowing the processing efficiency to be improved by parallel processing. In the example of JPEG that is one image compression scheme, all the pixels in the image to be compressed are divided into 8×8 blocks, which are all allowed to be processed in parallel. The processing allowing parallelism includes a parallel allowable algorithm of discrete cosine transformation (DCT), quantization, zigzag scanning, run-length processing and the like.

Conventional LSIs of DSP and ASIC often employ an architecture called SIMD (Single Instruction Multiple Data) to process these blocks in parallel. The SIMD architecture includes a plurality of processing elements (PE) internally to send the same instruction to each PE to process in parallel a plurality of different data at the same timing. The SIMD architecture is suitable for multimedia data processing.

In the architecture that performs parallel processing such as the SIMD architecture, the processing capability can be improved by reducing the bit length of the processing element so that the processing elements can be mounted constituting a smaller area to increase the parallelism. Although the parallelism can be improved by the design of a reduced bit width for the PE, there will be the problem that the number of clock cycles is increased for the processing of multiplication and the like. Multiplication is one operation often employed in multimedia processing. By realizing high-speed operation while implementing a multiplier with a few number of bits and small area, the processing such as for still pictures, motion pictures, audio, and the like can be rendered efficient, satisfying the needs of the users.

FIG. 20 represents a bit-parallel mode, whereas FIG. 21 represents a bit-serial mode.

For data processing employing the DSP and various SIMD architectures, there are generally two methods, i.e. the method of dividing each word into a plurality of blocks for parallel processing (hereinafter, referred to as “bit-parallel mode), as shown in FIG. 20, and the method of sequentially processing all the words (hereinafter, referred to as “bit-serial mode”), as shown in FIG. 21. The features of each method will be described hereinafter.

[Bit-Parallel Mode]

1. Since a plurality of PEs are provided corresponding to the bit length of one word, one word can be processed in about one clock cycle.

2. A plurality of words can be processed at one time corresponding to b blocks.

3. Since the bit width of processing is constant, there may be a PE that is not used in operation, depending upon the application.

4. The number of PEs required for the processing of one block increases in proportion to a longer bit length d of one word. More hardware resources will be required to improve the parallelism.

5. In the case where processing of one word is carried out in one clock cycle, “a” clock cycles will be required to process all the words.

6. The required number of PEs is (d×b).

[Bit-Serial Mode]

1 . Since a PE having a bit length of 1 to 2 will be prepared for one word, one word can be processed in a clock cycle substantially equal to a bit length d.

2. Parallel processing of (a×b) words is allowed in one processing.

3. Since the processing bit width is variable, PEs can be used effectively in accordance with the application.

4. Since the number of PEs required for one word is low, not so many hardware resources will be consumed even if the parallelism is increased.

5. The processing direction of data must be altered.

6. The total of “d” clock cycles will be required to process all the words.

7. The required number of PEs will be (a×b).

Multimedia application processing is mainly characterized in that the processing bit width is variable and that there are many processing words. It is desirable to increase “b” and decrease “a” as much as possible in order to perform multimedia application processing at high speed. Namely, the relationship of d<<b should be established. The bit-serial mode has been considered to be an architecture that can perform multimedia application processing efficiently.

As a configuration of performing bit-serial operation, Japanese Patent Laying-Open No. 2006-127460, for example, discloses a semiconductor device set forth below. Specifically, the semiconductor device includes a memory cell array having a plurality of memory cells arranged in a matrix and divided into a plurality of entries, a plurality of first processing circuits arranged corresponding to each of the entries to carry out each specified operation on the data of a corresponding entry, a plurality of data transfer lines through which data is transferred between each entry and a corresponding first processing circuit, and a plurality of data transfer circuits arranged corresponding to the plurality of data transfer lines, respectively, to transfer data bit-by-bit between a corresponding data transfer line and a corresponding first processing circuit in an entry-parallel manner, wherein each entry is loaded with multibit data, and each first processing circuit executes an operation on the multibit data of a corresponding entry in a bit-serial manner.

In a one-bit serial operation, the processing such as addition and subtraction can be performed in a clock cycle substantially equal to the bit length, whereas the processing such as multiplication and division will take as many clock cycles as at least the bit length to the second power. A possible approach is to increase the bit length of the processing element in order to reduce the clock cycles. Although the number of clock cycles may be reduced by increasing the bit length, the circuit occupying area will become larger, leading to the problem that the parallelism cannot be improved.

### SUMMARY OF THE INVENTION

An object of the present invention is to provide a semiconductor device allowing high speed operation and directed to improving parallelism by reducing the size.

In a semiconductor device according to an embodiment of the present invention, a decoder outputs a shift flag, an inversion flag, and an operation flag in accordance with Booth's algorithm. A partial product calculation unit outputs partial product data indicating the partial product of multiplier data and multiplicand data based on each flag received from the decoder.

In accordance with an embodiment of the present invention, the speed in processing can be increased and the parallelism can be improved by reducing the size.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a configuration of a semiconductor device according to a first embodiment of the present invention.

FIG. 2 is a circuit diagram of a configuration of a Booth decoder in the semiconductor device of the first embodiment.

FIG. 3 represents a truth table of the Booth decoder.

FIG. 4 is a circuit diagram representing a configuration of a selector cell in the semiconductor device of the first embodiment.

FIG. 5 represents a truth table of the selector cell.

FIG. 6 is a circuit diagram representing a configuration of a shift and add circuit in the semiconductor device of the first embodiment.

FIG. 7 represents a configuration of a modification of the semiconductor device of the first embodiment.

FIG. 8 represents a flow of multiplication processing performed by the semiconductor device of the first embodiment.

FIG. 9 represents a basic concept of operations other than the multiplication processing performed by a semiconductor device of the first embodiment.

FIG. 10 represents a flow of addition processing performed by the semiconductor device of the first embodiment.

FIG. 11 represents a flow of subtraction processing performed by the semiconductor device of the first embodiment.

FIG. 12 represents a flow of complement processing performed by the semiconductor device of the first embodiment.

FIG. 13 represents a flow of inversion processing performed by the semiconductor device of the first embodiment.

FIG. 14 represents a flow of 1-bit shift processing performed by the semiconductor device of the first embodiment.

FIG. 15 represents a flow of 2-bit shift processing performed by the semiconductor device of the first embodiment.

FIG. 16 represents a flow of 3-bit shift processing performed by the semiconductor device of the first embodiment.

FIG. 17 represents a configuration of a semiconductor device according to a second embodiment of the present invention.

FIG. 18 represents a configuration of adder and subtracter units in the semiconductor device of the second embodiment.

FIG. 19 represents a configuration of an output operation unit 95 in the semiconductor device of the second embodiment.

FIG. 20 represents a bit-parallel mode.

FIG. 21 represents a bit-serial mode.

### DESCRIPTION OF THE PREFERRED EMBODIMENTS

Embodiments of the present invention will be described hereinafter with reference to the drawings. In the drawings, the same or corresponding elements have the same reference characters allotted, and description thereof will not be repeated.

### First Embodiment

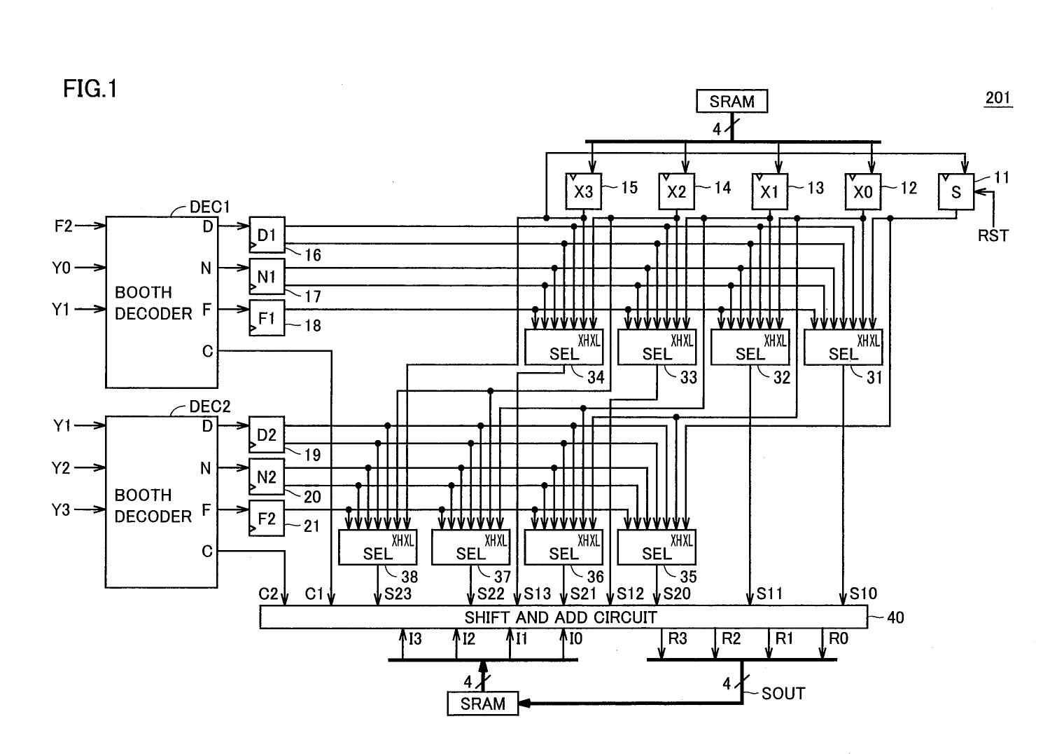

Referring to FIG. 1, a semiconductor device 201 according to a first embodiment of the present invention includes Booth decoders DEC1, DEC2, registers 11-21, selector cells (partial product calculation circuit) 31-38, and a shift and add circuit (partial product add circuit) 40. In data Y0-Y3 representing multipliers and data X0-X3 representing multiplicands in FIG. 1, the data of a lower number represents a lower order bit. The LSB is data Y0 and data X0. The MSB is data Y3 and data X3.

Each of Booth decoders DEC1 and DEC2 may also be referred generically as Booth decoder DEC hereinafter. Each of selector cells 31-38 may also be referred generically as selector cell SEL hereinafter.

Semiconductor device 201 is a 4-bit serial multiplier device, for example, performing multiplication sequentially for every 4 bits×4 bits.

Booth decoder DEC1 receives data Y0, Y1 representing multipliers and data from register 21 to output a shift flag D, an operation flag N, an inversion flag F, and a complement flag C1 to registers 16-18 and shift and add circuit 40, respectively, in accordance with Booth's algorithm.

Register 16 retains and outputs to selector cells 31-34 a shift flag D received from Booth decoder DEC1, and outputs data that is an inverted version of the logic level of the retained shift flag D to selector cells 31-34.

Register 17 retains and outputs to selector cells 31-34 an operation flag N received from Booth decoder DEC1, and outputs data that is an inverted version of the logic level of the retained operation flag N to selector cells 31-34.

Register 18 retains and outputs to selector cells 31-34 an inversion flag F received from Booth decoder DEC1.

Booth decoder DEC2 receives data Y1, Y2 and Y3 representing multipliers to output a shift flag D, an operation flag N, an inversion flag F, and a complement flag C2 to registers 19-21 and shift and add circuit 40, respectively, in accordance with Booth's algorithm.

Register 19 retains and outputs to selector cells 35-38 a shift flag D received from Booth decoder DEC2, and outputs data that is an inverted version of the logic level of the retained shift flag D to selector cells 35-38.

Register 20 retains and outputs to selector cells 35-38 an operation flag N received from Booth decoder DEC2, and outputs data that is an inverted version of the logic level of the retained operation flag N to selector cells 35-38.

Register 21 retains an inversion flag F received from Booth decoder DEC2 and outputs the same as data F2 to selector cells 35-38 and to Booth decoder DEC1.

Register 12 retains and outputs to selector cells 31, 32, 35 and 36 data X0 representing a multiplicand, received from an SRAM.

Register 13 retains and outputs to selector cells 32, 33, 36 and 37 data X1 representing a multiplicand, received from the SRAM.

Register 14 retains and outputs to selector cells 33, 34, 37 and 38 data X2 representing a multiplicand, received from SRAM.

Register 15 retains and outputs to selector cells 34 and 38 and to register 11 data X3 representing a multiplicand, received from the SRAM.

Register 11 retains and outputs to selector cells 31 and 35 data X3 received from register 15. Register 11 is reset by an externally applied reset signal RST.

Based on data received from register 11, data X0 received from register 12, shift flag D received from register 16 and inverted data thereof, operation flag N received from register 17 and inverted data thereof, and inversion flag F received from register 18, selector cell 31 calculates the partial product of 2-bit multiplicand data having the data received from register 11 as the lower order bit and data X0 as the higher order bit and 3-bit multiplier data having data F2 as the least significant bit, data Y0 as the second bit, and data Y1 as the most significant bit, and outputs the calculated result to shift and add circuit 40 as partial product S10.

Based on data X0 received from register 12, data X1 received from register 13, shift flag D received from register 16 and inverted data thereof, operation flag N received from register 17 and inverted data thereof, and inversion flag F received from register 18, selector cell 32 calculates the partial product of 2-bit multiplicand data having data X0 as the lower order bit and data X1 as the higher order bit and 3-bit multiplier data having data F2 as the least significant bit, data Y0 as the second bit, and data Y1 as the most significant bit, and outputs the calculated result to shift and add circuit 40 as partial product S11.

Based on data X1 received from register 13, data X2 received from register 14, shift flag D received from register 16 and inverted data thereof, operation flag N received from register 17 and inverted data thereof, and inversion flag F received from register 18, selector cell 33 calculates the partial product of 2-bit multiplicand data having data X1 as the lower order bit and data X2 as the higher order bit and 3-bit multiplier data having data F2 as the least significant bit, data Y0 as the second bit, and data Y1 as the most significant bit, and outputs the calculated result to shift and add circuit 40 as partial product S12.

Based on data X2 received from register 14, data X3 received from register 15, shift flag D received from register 16 and inverted data thereof, operation flag N received from register 17 and inverted data thereof, and inversion flag F received from register 18, selector cell 34 calculates the partial product of 2-bit multiplicand data having data X2 as the lower order bit and data X3 as the higher order bit and 3-bit multiplier data having data F2 as the lower order bit, data Y0 as the second bit, and data Y1 as the most significant bit, and outputs the calculated result to shift and add circuit 40 as partial product S13.

Based on the data received from register 11, data X0 received from register 12, shift flag D received from register 19 and inverted data thereof, operation flag N received from register 20 and inverted data thereof, and inversion flag F received from register 21, selector cell 35 calculates the partial product of 2-bit multiplicand data having the data received from register 11 as the lower order bit and data X0 as the higher order bit and 3-bit multiplier data having data Y1 as the least significant bit, data Y2 as the second bit, and data Y3 as the most significant bit, and outputs the calculated result to shift and add circuit 40 as partial product S20.

Based on data X0 received from register 12, data X1 received from register 13, shift flag D received from register 19 and inverted data thereof, operation flag N received from register 20 and inverted data thereof, and inversion flag F received from register 21, selector cell 36 calculates the partial product of 2-bit multiplicand data having data X0 as the lower order bit and data X1 as the higher order bit and 3-bit multiplier data having data Y1 as the least significant bit, data Y2 as the second bit, and data Y3 as the most significant bit, and outputs the calculated result to shift and add circuit 40 as partial product S21.

Based on data X1 received from register 13, data X2 received from register 14, shift flag D received from register 19 and inverted data thereof, operation flag N received from register 20 and inverted data thereof, and inversion flag F received from register 21, selector cell 37 calculates the partial product of 2-bit multiplicand data having data X1 as the lower order bit and data X2 as the higher order bit and 3-bit multiplier data having data Y1 as the least significant bit, data Y2 as the second bit, and data Y3 as the most significant bit, and outputs the calculated result to shift and add circuit 40 as partial product S22.

Based on data X2 received from register 14, data X3 received from register 15, shift flag D received from register 19 and inverted data thereof, operation flag N received from register 20 and inverted data thereof, and inversion flag F received from register 21, selector cell 38 calculates the partial product of 2-bit multiplicand data having data X2 as the lower order bit and data X3 as the higher order bit and 3-bit multiplier data having data Y1 as the least significant bit, data Y2 as the second bit, and data Y3 as the most significant bit, and outputs the calculated result to shift and add circuit 40 as partial product S23.

Based on partial products S10, S11, S12, S13, S20, S21, S22 and S23 received from selector cells 31-38, respectively, and complement flags C1 and C2 received from Booth decoders DEC1 and DEC2, respectively, shift and add circuit 40 calculates the multiplication of data X0-X3 and data Y0-Y3 by adding partial products S10, S11, S12, S13, S20, S21, S22 and S23.

Data I0-I3 represent the accumulated value up to the multiplication result of the preceding stage in serial multiplication. Shift and add circuit 40 adds the calculated multiplication result and data I0-I3 received from the SRAM to output data R0-R3 of 4 bits indicating the addition result to the SRAM as data SOUT. Semiconductor device 201 may be configured to include the SRAM.

In the case where multiplicand data is shifted based on the decoding of the multiplier (hereinafter, also referred to as Booth decode) in accordance with Booth's algorithm, register 11 complements the shifted result, i.e. output data from register 15.

When a shift operation is performed, the output data from registers 11-14 are the subject of operation.

Each of data X0-X3 may also be referred generically as data X. Each of data Y0-Y3 may also be referred generically as data Y. Each of partial products S10, S11, S12, S13, S20, S21, S22 and S23 may also be referred generically as partial products S.

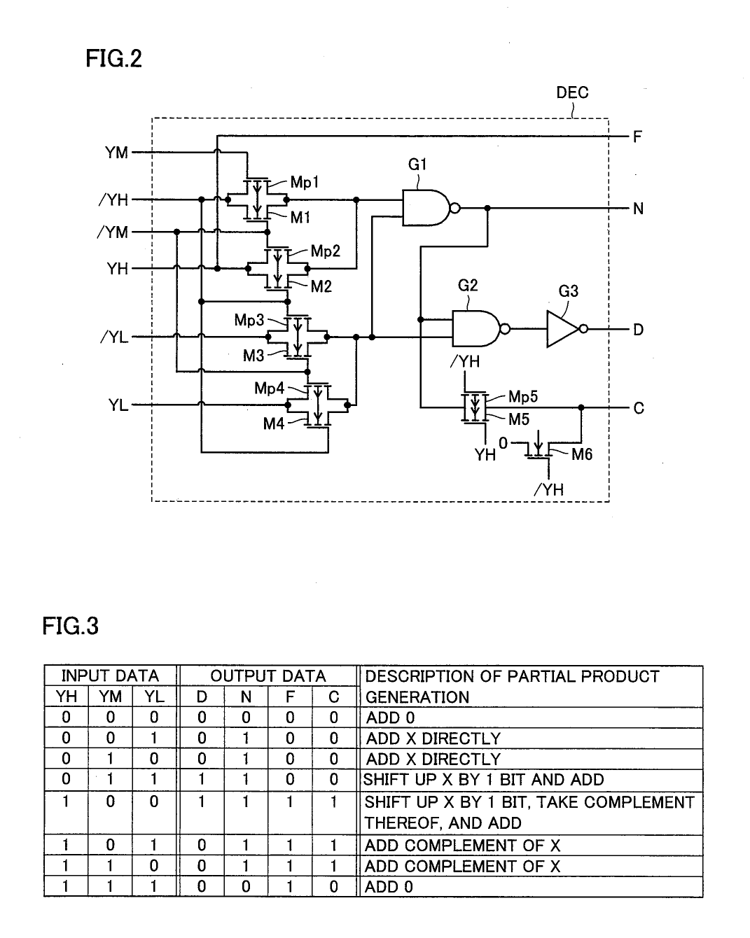

Referring to the circuit diagram of FIG. 2 representing a configuration of a Booth decoder in the semiconductor device of the first embodiment, data YL, YM, and YH represent data F2, Y0, and Y1, respectively, in Booth decoder DEC1, and represent data Y1, Y2, and Y3, respectively, in Booth decoder DEC2. Further, data /YL, /YM, and /YH represents the inverted data of the logic level of YL, YM, and YH. D, N, F, and C represent a shift flag, an operation flag, an inversion flag, and a complement flag, respectively.

Referring to FIG. 2, Booth decoder DEC includes N channel MOS transistors M1-M6, P channel MOS transistors Mp1-Mp5, NAND gates G1 and G2, and a NOT gate G3.

P channel MOS transistor Mp1 includes a gate receiving data YM, a source receiving data /YL, and a drain. N channel MOS transistor M1 includes a gate receiving data /YM, a drain receiving data /YH, and a source. P channel MOS transistor Mp2 includes a gate receiving data /YM, a source receiving data YL, and a drain. N channel MOS transistor M2 includes a gate receiving data /YH, a drain receiving data YL, and a source.

P channel MOS transistor Mp3 includes a gate receiving data /YH, a source receiving data /YL, and a drain. N channel MOS transistor M3 includes a gate receiving data /YM, a drain receiving data /YL, and a source. P channel MOS transistor Mp4 includes a gate receiving data /YM, a source receiving data YL, and a drain. N channel MOS transistor M4 includes a gate receiving data /YH, a drain receiving data YL, and a source.

NAND gate G1 includes a first input terminal connected to the drains of P channel MOS transistors Mp1 and Mp2 and the sources of N channel MOS transistors M1 and M2, and a second input terminal connected to the drains of P channel MOS transistors Mp3 and Mp4 and the sources of N channel MOS transistors M3 and M4.

NAND gate G2 includes a first input terminal connected to the output terminal of NAND gate G1, and a second input terminal connected to the drains of P channel MOS transistors Mp3 and Mp4 and the sources of N channel MOS transistors M3 and M4.

P channel MOS transistor Mp5 includes a gate receiving data /YH, a source connected to the output terminal of NAND gate G1, and a drain. N channel MOS transistor M5 includes a gate receiving data YH, a drain connected to the output terminal of NAND gate G1, and a source. N channel MOS transistor M6 includes a gate receiving data /YH, a drain receiving a signal of a logical low level, i.e. a signal indicating 0, and a source. The drain of P channel MOS transistor Mp5 and the sources of N channel MOS transistors M5 and M6 are connected to each other. The voltage of the connection node thereof is output as complement flag C.

NAND gate G1 outputs data that is an inverted version of the logical AND of the data received at the first input terminal and the data received at the second input terminal as an operation flag N. Further, data YH is output as inversion flag F. NAND gate G2 outputs data that is an inverted version of the logical AND of the data received at the first input terminal and the data received at the second input terminal to NOT gate G3. NOT gate G3 inverts the logic level of the data received from NAND gate G2, and outputs the inverted data as shift flag D.

Referring to FIG. 3 representing the truth table of a Booth decoder, Booth decoder DEC outputs 0, 0, 0 and 0 for shift flag D, operation flag N, inversion flag F, and complement flag C, respectively, when input data YH, YM and YL all are 0. In this case, at selector cell SEL and shift and add circuit 40, 0 is added as the partial product in the multiplication of data X0-X3 and data Y0-Y3. When each of the input data YH, YM, and YL is 0, 0, and 1, respectively, Booth decoder DEC outputs 0, 1, 0 and 0 for shift flag D, operation flag N, inversion flag F and complement flag C, respectively. In this case, at selector SEL and shift and add circuit 40, corresponding data X is directly added as the partial product in the multiplication of data X0-X3 and data Y0-Y3.

When each of the input data YH, YM, and YL is 0, 1, and 0, respectively, Booth decoder DEC outputs 0, 1, 0 and 0 for shift flag D, operation flag N, inversion flag F and complement flag C, respectively. In this case, at selector SEL and shift and add circuit 40, corresponding data X is directly added as the partial product in the multiplication of data X0-X3 and data Y0-Y3.

When each of the input data YH, YM, and YL is 0, 1, and 1, respectively, Booth decoder DEC outputs 1, 1, 0 and 0 for shift flag D, operation flag N, inversion flag F and complement flag C, respectively. In this case, at selector SEL and shift and add circuit 40, data that is a shifted up version of corresponding data X by 1 bit is added as the partial product in the multiplication of data X0-X3 and data Y0-Y3.

When each of the input data YH, YM, and YL is 1, 0, and 0, respectively, Booth decoder DEC outputs 1, 1, 1 and 1 for shift flag D, operation flag N, inversion flag F and complement flag C, respectively. In this case, at selector SEL and shift and add circuit 40, complement data of the data that is a shifted up version of corresponding data X by 1 bit is added as the partial product in the multiplication of data X0-X3 and data Y0-Y3.

When each of the input data YH, YM, and YL is 1, 0, and 1, respectively, Booth decoder DEC outputs 0, 1, 1 and 1 for shift flag D, operation flag N, inversion flag F and complement flag C, respectively. In this case, at selector SEL and shift and add circuit 40, complementary data of corresponding data X is added as the partial product in the multiplication of data X0-X3 and data Y0-Y3.

When each of the input data YH, YM, and YL is 1, 1, and 0, respectively, Booth decoder DEC outputs 0, 1, 1 and 1 for shift flag D, operation flag N, inversion flag F and complement flag C, respectively. In this case, at selector SEL and shift and add circuit 40, complementary data of corresponding data X data is added as the partial product in the multiplication of data X0-X3 and data Y0-Y3.

When each of the input data YH, YM, and YL is 1, 1, and 1, respectively, Booth decoder DEC outputs 0, 0, 1 and 0 for shift flag D, operation flag N, inversion flag F and complement flag C, respectively. In this case, at selector SEL and shift and add circuit 40, 0 is added as the partial product in the multiplication of data X0-X3 and data Y0-Y3.

Booth decoder DEC is a circuit that decodes a multiplier in accordance with the so-called Booth's algorithm.

It is to be noted that a general Booth decoder in accordance with Booth's algorithm decodes the multiplier into a signed binary of 3 digits, whereas Booth decoder DEC in the semiconductor device according to the first embodiment of the present invention decodes the multiplier to a shift flag D, an inversion flag F, an operation flag N and a complement flag C.

By applying shift flag D, inversion flag F and operation flag N to selector cell SEL that will be described afterwards, a partial product is generated. In addition, complement flag C is input to shift and add circuit 40 to execute complement processing.

By just adding one booth decoder DEC for every increase of 2 bits of the multiplier bit, a circuit configuration of m bits×n bits can be accommodated in a generalized manner.

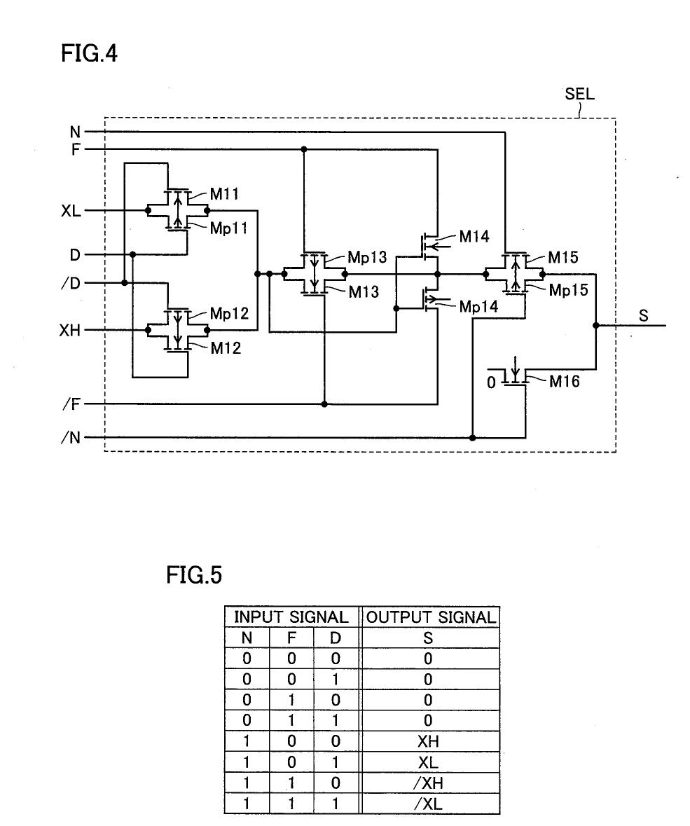

FIG. 4 is a circuit diagram representing a configuration of a selector cell in the semiconductor device of the first embodiment. In FIG. 4, /D, /N and /F represent data that is an inverted version of the logic level of the shift flag, operation flag, and inversion flag, respectively. XL represents the lower order bit of the multiplicand whereas XH represents the higher order bit of the multiplicand.

Referring to FIG. 4, selector cell SEL includes N channel MOS transistors M11-M16, and P channel MOS transistors Mp11-Mp15.

N channel MOS transistor M11 includes a gate receiving shift flag /D, a drain receiving data XL, and a source. P channel MOS transistor Mp11 includes a gate receiving shift flag D, a source receiving data XL, and a drain. N channel MOS transistor M12 includes a gate receiving shift flag D, a drain receiving data XH, and a source. P channel MOS transistor Mp12 includes a gate receiving shift flag /D, a source receiving data XH, and a drain. P channel MOS transistor Mp13 includes a gate receiving inversion flag F, a source, and a drain. N channel MOS transistor M13 includes a gate receiving inversion flag /F, a drain, and a source. N channel MOS transistor M14 includes a gate, a drain receiving inversion flag F, and a source. P channel MOS transistor Mp14 includes a gate connected to the sources of N channel MOS transistors M11 and M12, the drains of P channel MOS transistors Mp11 and Mp12, the sources of P channel MOS transistors Mp13, the drain of N channel MOS transistor M13, and the gate of N channel MOS transistor M14, a drain receiving inversion flag /F, and a source. N channel MOS transistor M15 includes a gate receiving operation flag N, a drain, and a source. P channel MOS transistor Mp15 includes a gate receiving operation flag /N, a source connected to the drain of P channel MOS transistors Mp13, the source of P channel MOS transistors Mp14, the sources of N channel MOS transistors M13 and M14, and the drain of N channel MOS transistor M15, and a drain. N channel MOS transistor M16 includes a gate receiving an operation flag /N, a drain receiving a signal of a logical low level, and a source. The drain of P channel MOS transistor Mp15 and the sources of N channel MOS transistors M15 and M16 are connected to each other. The voltage of this connection node is output as partial product S.

FIG. 5 represents a truth table of the selector cell.

Referring to FIG. 5, selector cell SEL outputs 0 as partial product S when operation flag N, inversion flag F, and shift flag D are 0, 0, 0, respectively.

Selector cell SEL outputs 0 as partial product S when operation flag N, inversion flag F and shift flag D are 0, 0 and 1, when operation flag N, inversion flag F and shift flag D are 0, 1 and 0, and when operation flag N, inversion flag F and shift flag D are 0, 1 and 1.

When operation flag N, inversion flag F, and shift flag D are 1, 0 and 0, respectively, selector cell SEL outputs data XH as partial product S.

When operation flag N, inversion flag F, and shift flag D are 1, 0 and 1, respectively, selector cell SEL outputs data XL as partial product S.

When operation flag N, inversion flag F, and shift flag D are 1, 1 and 0, respectively, selector cell SEL outputs data /XH that is an inverted version of the logic level of data XH, as partial product S.

When operation flag N, inversion flag F, and shift flag D are 1, 1 and 1, respectively, selector cell SEL outputs data /XL that is an inverted version of the logic level of data XL, as partial product S.

Thus, selector cell SEL calculates a partial product based on operation flag N, inversion flag F and shift flag D decoded in accordance with Booth's algorithm.

More specifically, referring to FIG. 4 again, a selection circuit constituted of P channel MOS transistors Mp11 and Mp12 and N channel MOS transistors M11 and M12 select whether to shift the multiplicand data input to selector cell SEL based on shift flag D. The selection circuit directly outputs data XH when shift flag D is 0, and outputs data XL that is lower by 1 bit than data XH when shift data D is 1.

The exclusive OR circuit constituted of P channel MOS transistors Mp13 and Mp14, and N channel MOS transistors M13 and M14 inverts data XL or data XH selected by the selection circuit when inversion flag F is 1 and outputs the inverted data. When inversion flag F is 0, the exclusive OR circuit outputs data XL or data XH selected by the selection circuit directly to N channel MOS transistor M15 and P channel MOS transistor Mp15.

The circuit constituted of P channel MOS transistor Mp15 and N channel MOS transistors M15 and M16 outputs the data received from the above-described exclusive OR circuit and data indicating 0 when operation flag N is 1 and 0, respectively, as partial product S.

By taking the circuit configuration of selector cell SEL shown in FIG. 4 as one unit, a multiplier circuit with increased multiplier bits and multiplicand bits can be readily implemented.

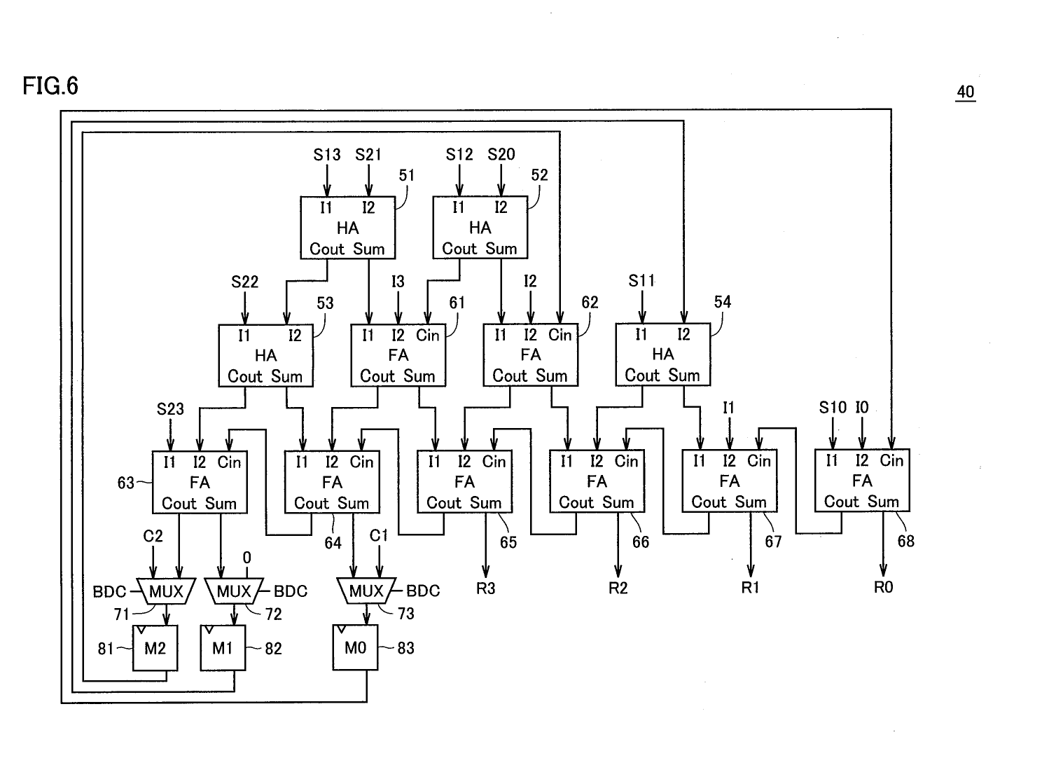

FIG. 6 is a circuit diagram of a configuration of a shift and add circuit in the semiconductor device of the first embodiment.

Referring to FIG. 6, shift and add circuit 40 is a circuit for 4 bits×4 bits, for example, and includes half adders (HA) 51-54, full adders (FA) 61-68, multiplexers (MUX) 71-73, and registers 81-83.

Half adder 51 adds partial products S13 and S21, and outputs the lower order bit of the addition result to full adder 61 as data Sum, and outputs the higher order bit of the addition result, i.e. the shift-up value, to half adder 53 as carry output Cout.

Half adder 52 adds partial products S12 and S20, and outputs the lower order bit of the addition result to full adder 62 as data Sum, and outputs the higher order bit of the addition result, i.e. the shift-up value, to full adder 61 as carry output Cout.

Half adder 53 adds partial product S22 and carry output Cout received from half adder 51 to output the lower order bit of the addition result to full adder 64 as data Sum, and the higher order bit of the addition result, i.e. the shift-up value, to full adder 63 as carry output Cout.

Full adder 61 receives carry output Cout from half adder 52 as carry input Cin, i.e. the shift-up value, and adds the same with data Sum received from half adder 51 and data 13 received from the SRAM to output the lower order bit of the addition result to full adder 65 as data Sum and to output the higher order bit of the addition result, i.e. the shift-up value, to full adder 64 as carry output Cout.

Full adder 62 receives the data from register 81 as carry input Cin, i.e. the shift-up value, and adds the same with data Sum received from half adder 52 and data I2 received from the SRAM to output the lower order bit of the addition result to full adder 66 as data Sum and to output the higher order bit of the addition result, i.e. the shift-up value, to full adder 65 as carry output Cout.

Half adder 54 adds partial product S11 and the data received from register 82 to output the lower order bit of the addition result to full adder 67 as data Sum, and to output the higher order bit of the addition result, i.e. the shift-up value, to full adder 66 as carry output Cout.

Full adder 63 receives carry output Cout from full adder 64 as carry input Cin, i.e. shift-up value, and adds the same with partial product S23 and carry output Cout from half adder 53 to output the lower order bit of the addition result to multiplexer 72 as data Sum, and to output the higher order bit of the addition result, i.e. the shift-up value, to multiplexer 71 as carry output Cout.

Full adder 64 receives carry output Cout from full adder 65 as carry input Cin, i.e. the shift-up value, and adds the same with data Sum received from half adder 53 and carry output Cout received from full adder 61 to output the lower order bit of the addition result to multiplexer 73 as data Sum, and to output the higher order bit of the addition result, i.e. the shift-up value, to full adder 63 as carry output Cout.

Full adder 65 receives carry output Cout from full adder 66 as carry input Cin, i.e. the shift-up value, and adds the same with data Sum received from full adder 61 and carry output Cout received from full adder 62 to output the lower order bit of the addition result as data R3, and to output the higher order bit of the addition result, i.e. the shift-up value, to full adder 64 as carry output Cout.

Full adder 66 receives carry output Cout from full adder 67 as carry input Cin, i.e. the shift-up value, and adds the same with data Sum received from full adder 62 and carry output Cout received from half adder 54 to output the lower order bit of the addition result as data R2, and to output the higher order bit of the addition result, i.e. the shift-up value, to full adder 65 as carry output Cout.

Full adder 67 receives carry output Cout from full adder 68 as carry input Cin, i.e. the shift-up value, and adds the same with data Sum received from half adder 54 and data I1 received from the SRAM to output the lower order bit of the addition result as data R1, and to output the higher order bit of the addition result, i.e. the shift-up value, to full adder 66 as carry output Cout.

Full adder 68 receives the data from register 83 as carry input Cin, i.e. a shift-up value, and adds the same with partial product S10 and data I0 from the SRAM to output the lower order bit of the addition result as data RO, and the higher order bit of the addition result, i.e. the shift-up value, to full adder 67 as carry output Cout.

Based on a control signal BDC, multiplexer 71 selects one of complement flag C2 received from Booth decoder DEC2 and carry output Cout received from full adder 63 to output the selected data to register 81. Based on control signal BDC, multiplexer 72 selects one of data Sum received from full adder 63 and data indicating 0 to output the selected data to register 82. Based on control signal BDC, multiplexer 73 selects one of complement flag C1 received from Booth decoder DEC1 and data Sum received from full adder 64 to output the selected data to register 83.

Register 81 retains and outputs to full adder 62 the data from multiplexer 71. Register 82 retains and outputs to half adder 54 the data from multiplexer 72. Register 83 retains and outputs to full adder 68 the data from multiplexer 73.

Thus, shift and add circuit 40 adds the partial product output from selector cell SEL and the value of complement flag C or the like. Specifically, shift and add circuit 40 adds partial products S10-S13 and S20-S23 output from selector cell SEL, accumulated values I0-I3 up to the multiplication result of the preceding stage in serial multiplication, and the higher order bit of the addition result preceded by 1 clock in shift and add circuit 40 or complement flag C.

Data R0-R3 that are the lower order bits of the addition result in shift and add circuit 40 are output, and the higher order bits are stored in feedback registers 81-83 to be added at the next clock timing.

Shift and add circuit 40 has a configuration employing the Wallace tree that can implement an adder most efficiently. In bit-serial operation, shift and add circuit 40 is characterized in that there is no feedback of the higher order bit when the least significant bit of data X that is a multiplicand is handled. Shift and add circuit 40 is also characterized in that complement flag C is not necessary when data other than the least significant bit of data X that is the multiplicand is handled. Therefore, shift and add circuit 40 selects either the higher order bit data or complement flag C by multiplexers 71-73. More specifically, control signal BDC is rendered active when the least significant bit data is handled among data X that is the multiplicand. In response, multiplexers 71-73 select complement flag C2, data indicating 0, and complement flag C1, respectively. By such a configuration, the circuit complexity can be reduced.

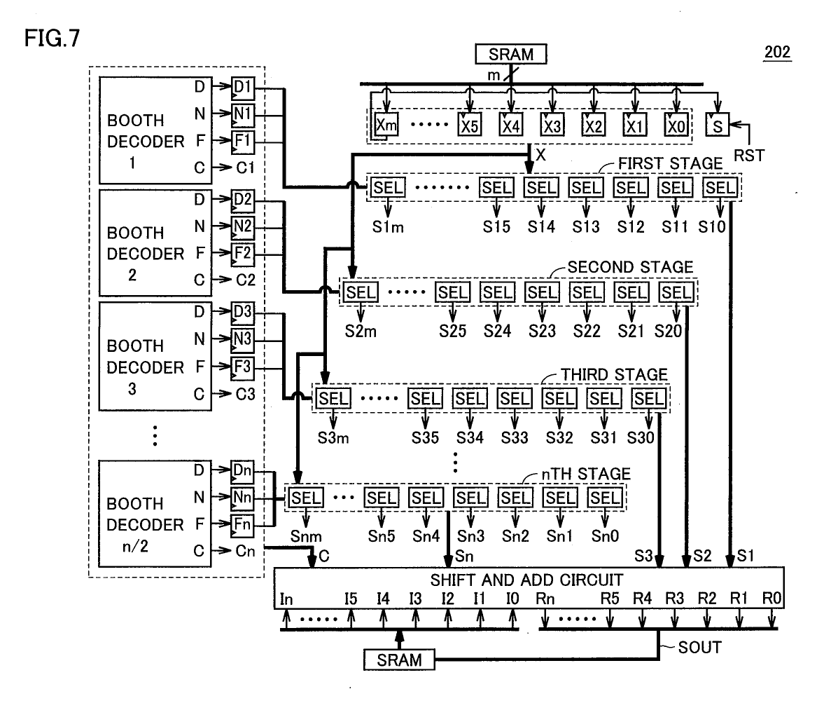

FIG. 7 represents a configuration of a modification of the semiconductor device of the first embodiment.

Referring to FIG. 7, a semiconductor device 202 has an expanded configuration of semiconductor device 201 that is a 4-bit×4-bit serial multiplier having the multiplicand of 4 bits and the multiplier of 4 bits. Semiconductor device 202 is an m-bit×n-bit serial multiplier having the multiplicand of m bits and the multiplier of n bits.

Semiconductor device 202 includes n/2 Booth decoders DEC, (m×n/2) selector cells SEL, and a shift and add circuit for m bits×n bits.

The semiconductor device according to the first embodiment of the present invention allows higher parallelism by reducing the circuit area, and also allows signed multiplication at high speed. By sequentially performing serial processing, an operation of variable length is allowed. In addition, execution of addition and subtraction operations frequently occurring in multimedia processing is allowed. Thus, multimedia data can be processed effectively.

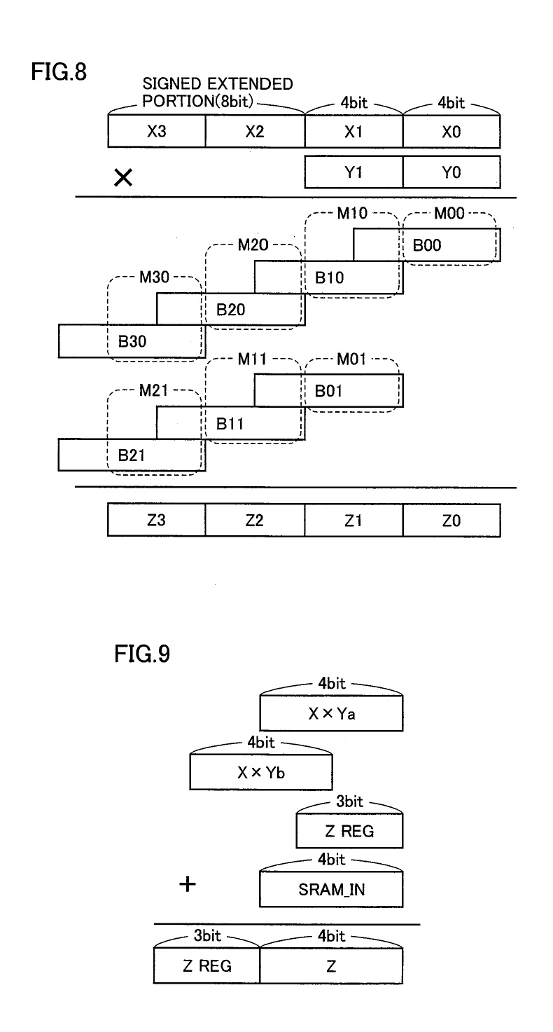

FIG. 8 represents the flow of multiplication processing of 8 bits×8 bits, performed by the semiconductor device according to the first embodiment of the present invention.

Referring to FIG. 8, X is the multiplicand, Y15 is the multiplier used in Booth decoding, and Z is the calculation result. Bab is the partial product of Xa and Yb. Mab is the sum of the lower 4 digits of the partial product of Xa and Yb and the higher 3 digits of the partial product of the preceding stage.

Calculation result Z can be obtained by adding up each partial product Mab as in the following equations.

Z0=M00

Z1=M10+M01

Z2=M20+M11

Z3=M30+M21

The flow of the operational processing will be described hereinafter.

1. Y0 is input and decoding is executed in accordance with Booth's algorithm to set the D/N/F/C flags.

2. X0 is input, and the partial product B00 of X0×Y0 is calculated. The lower 4 bits of B00 is taken as M00. M00 is directly taken as Z0.

3. X1 is input, and the partial product B10 of X1×Y0 is calculated. The sum of the lower 4 bits of B10 and the higher 3 bits of B00 is output as M10.

4. X2 is input, and the partial product B20 of X2×Y0 is calculated. The sum of the lower 4 bits of B20 and the higher 3 bits of B10 is output as M20.

5. X3 is input, and the partial product B30 of X3×Y0 is calculated. The sum of the lower 4 bits of B30 and the higher 3 bits of B20 is output as M30.

6. Y1 is input and decoding is executed in accordance with Booth's algorithm to set the D/N/F/C flags.

7. X0 is input, and the partial product B01 of X0×Y1 is calculated. The lower 4 bits of B01 are taken as M01. Let the sum of M01 and M10 be Z1.

8. X1 is input, and the partial product B11 of X1×Y1 is calculated. The sum of the lower 4 bits of B11 and the higher 3 bits of B01 is taken as M11. Let the sum of M11 and M20 be Z2.

9. X2 is input, and the partial product B21 of X2×Y1 is calculated. The sum of the lower 4 bits of B21 and the higher 3 bits of B11 is taken as M21. Let the sum of M21 and M30 be Z3.

Semiconductor device 201 performs Booth decoding and partial product addition, as set forth above, to calculate Z* (* is 0 to 3). For example, in the operation of obtaining Z0, the aforementioned X0 of 4 bits are stored in registers 12-15, and the aforementioned Y0 of 4 bits are subjected to Booth decoding.

Shift and add circuit 40 adds the data shifted and inverted data based on the Booth decode result to calculate partial product B** (** is 00, 10, 20, 30, 01, 11, 21). Shift and add circuit 40 adds each partial product and stores the addition result into the SRAM as Z*.

FIG. 9 represents a basic concept of operations other than the multiplication operation performed by a semiconductor device of the first embodiment. FIG. 9 represents the operational processing flow of 8 bits×8 bits.

The bit serial multiplier based on Booth's algorithm is capable of an operation other than multiplication. The bit serial multiplier can perform addition, subtraction, complement, inversion and shifting operations by utilizing a value based on two Booth decoded results, an input from an SRAM, and a feedback of the higher order bit.

Referring to FIG. 9, X stands for the target numeral of operation, and Y stands for the numeral used for the shifting and complement operation. Ya stands for the lower 2 bits of Y+ the value of F2 register, i.e. the value retained in register 21. Yb stands for the value of the higher 3 bits of Y. Z stands for the calculation result. ZREG stands for the value in the register for carry, i.e. the value retained in registers 81-83. SRAMIN stands for the input value from the SRAM.

Booth decoder DEC calculates X×Ya (first stage) and X×Yb (second stage), which are added together with the values of ZREG and SRAMIN. The lower 4 bits of the addition result are output as Z, and the higher 3 bits are fed back as ZREG at the next clock timing. In other words, the processing of addition, subtraction, complement, inversion and shifting can be carried out by the operation of X×Y+SRAMIN+ZREG.

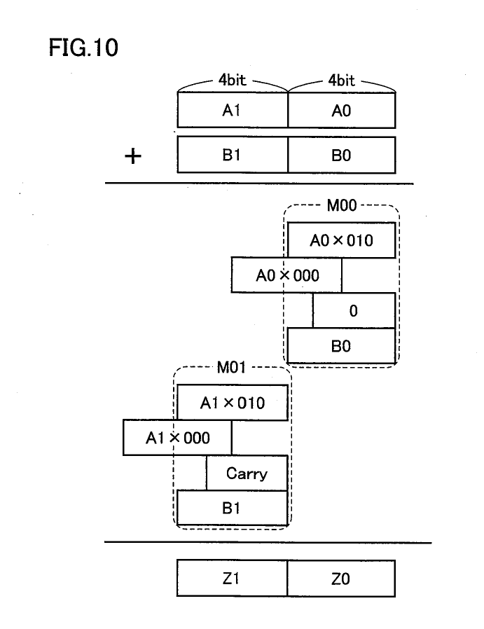

FIG. 10 represents the addition processing flow of 8 bits×8 bits performed by the semiconductor device according to the first embodiment.

In addition processing, the operation is carried out by the inputs of X=A, Y=0001, F2=0, SRAMIN=B.

Referring to FIG. 10, A stands for the augend, A0 the value of the lower 4 bits of A, and A1 the value of the higher 4 bits of A. B stands for the addend, B0 the value of the lower 4 bits of B, and B1 the value of the higher 4 bits of B. Ya stands for the lower 2 bits of Y+the value of F2 register. Yb stands for the value of the higher 3 bits of Y. Z stands for the calculation result.

The operational processing flow will be described hereinafter.

1. Ya=010, Yb=000 are input, followed by decoding in accordance with Booth's algorithm to set the flag.

2. X=A0, SRAMIN=B0 are input. As the calculation result of A0×Ya, A0 is directly output. As the calculation result of A0×Yb, 0000 is output.

3. The carry 0 is input to ZREG. A0+B0 is output as Z0.

4. X=A1 is input, and SRAMIN=B1 is input. As the calculation result of A1×Ya, A1 is directly output. As the calculation result of A1×Yb, 0000 is output. Further, the carry generated at the clock timing of one preceding clock is output as ZREG.

5. The carry is input to ZREG, and A1+B1+carry are output as Z1.

By repeating the processing of 1 to 5 set forth above, the addition of 8 bits or more can be performed.

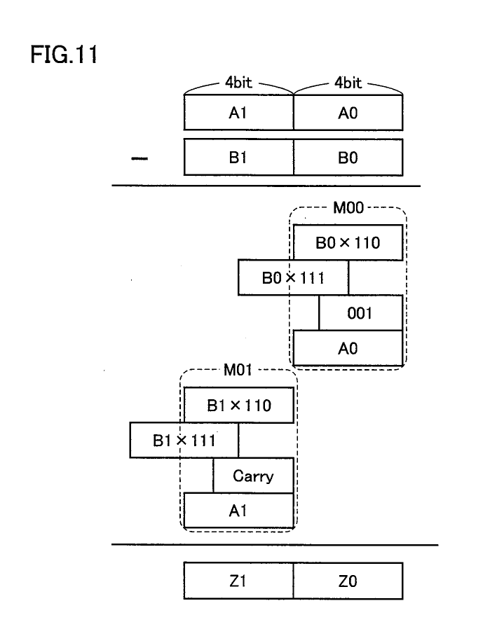

FIG. 11 represents the subtraction processing flow of 8 bits×8 bits performed by the semiconductor device according to the first embodiment.

In subtraction processing, the operation is performed by the inputs of X=B, Y=1111, F2=0, and SRAMIN=A.

Referring to FIG. 11, A stands for the minuend, A0 the lower 4 bits of A, and A1 the higher 4 bits of A. B stands for the subtrahend, B0 the lower 4 bits of B, and B1 the higher 4 bits of B. Ya stands for the lower 2 bits of Y+the value of F2 register. Yb stands for the value of the higher 3 bits of Y. Z stands for the calculation result.

The operational processing flow will be described hereinafter.

1. Ya=110, Yb=111 are input, followed by decoding in accordance with Booth's algorithm to set the flag.

2. X=B0, SRAMIN=A0 are input. As the calculation result of B0×Ya, the complement of B0 is output. As the calculation result of B0×Yb, 0000 is output.

3. The carry 001 is input to ZREG. A0+(−B0) is output as Z0.

4. X=B1, SRAMIN=A1 are input. As the calculation result of B1×Ya, the complement of B1 is output. As the calculation result of B1×Yb, 0000 is output. Further, the carry generated at the clock timing of one preceding clock is output as ZREG.

5. The carry is input to ZREG, and A1+(−B1)+carry are output as Z1.

By repeating the processing of 1 to 5 set forth above, the subtraction of 8 bits or more can be performed.

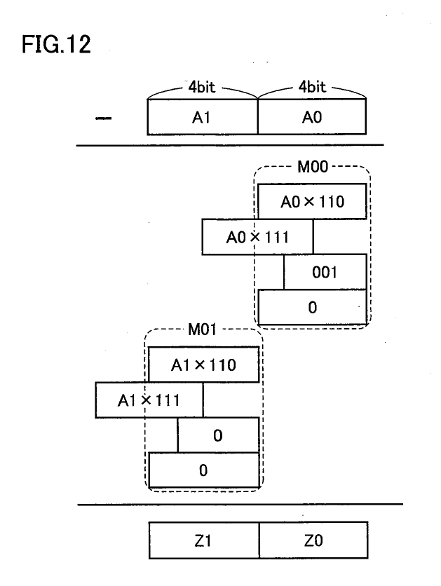

FIG. 12 represents a complement processing flow of 8 bits×8 bits performed by the semiconductor device according to the first embodiment.

In complement processing, an operation is performed by the inputs of X=A, Y=1111, F2=0, and SRAMIN=0.

Referring to FIG. 12, A stands for the minuend, A0 the lower 4 bits of A, and A1 the higher 4 bits of A. Ya stands for the lower 2 bits of Y+the value of F2 register. Yb stands for the value of the higher 3 bits of Y. Z stands for the calculation result.

The operational processing flow will be described hereinafter.

1. Ya=110, Yb=111 are input, followed by decoding in accordance with Booth's algorithm to set the flag.

2. X=A0, SRAMIN=0 are input. As the calculation result of A0×Ya, the complement of A0 is output.

3. The carry 001 is input to ZREG. −A0 is output as Z0.

4. X=A1, SRAMIN=0 are input. As the calculation result of A1×Ya, the complement of A1 is output. Further, the carry generated at the clock timing of one preceding clock is output as ZREG.

5. The carry is input to ZREG, and −A1+ carry are output as Z1.

By repeating the processing of 1 to 5 set forth above, the complement operation of 8 bits or more can be performed.

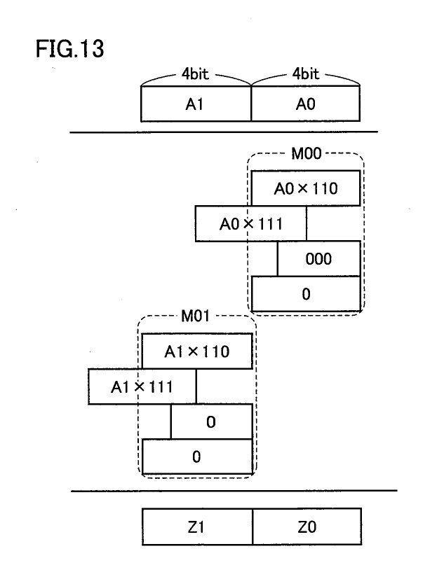

FIG. 13 represents an inversion processing flow of 8 bits×8 bits performed by the semiconductor device according to the first embodiment.

In inversion processing, an operation is carried out by the inputs of X=A, Y=1111, F2=0, SRAMIN=0.

Referring to FIG. 13, A stands for the value before inversion processing, A0 the lower 4 bits of A, and A1 the higher 4 bits of A. Ya stands for the lower 2 bits of Y+the value of F2 register. Yb stands for the value of the higher 3 bits of Y. Z stands for the calculation result.

The operational processing flow will be described hereinafter.

1. Ya=110, Yb=111 are input, followed by decoding in accordance with Booth's algorithm to set the flag.

2. X=0, SRAMIN=0 are input. The higher order bits 000 of the calculation result are stored in the carry register.

3. Ya=110, Yb=111 are input, followed by decoding in accordance with Booth's algorithm to set the flag. The carry flag is not saved and the data up to the preceding clock is retained.

4. X=A0, SRAMIN=0 are input. As the calculation result of A0×Ya, the inverted data of A0 is output.

5. −A0 is output as Z0.

6. X=A1, SRAMIN=0 are input. As the calculation result of A1×Ya, the inverted data of A1 is output.

7. The inverted data of A1 is output as Z1.

By repeating the processing of 1-7 set forth above, an inversion processing of 8 bits or more can be carried out.

The arithmetic shifting operation performed by the semiconductor device according to the first embodiment of the present invention will be described hereinafter. In a 4-bit circuit, m-bit shifting can be realized by the combination of a 1-bit shift to a 4-bit shift. For example, a 7-bit shift can be realized by the combination of a 3-bit shift and a 4-bit shift. Since a 4-bit shift can be realized by copying data, a 1-bit shift, a 2-bit shift, and a 3-bit shift will be described hereinafter.

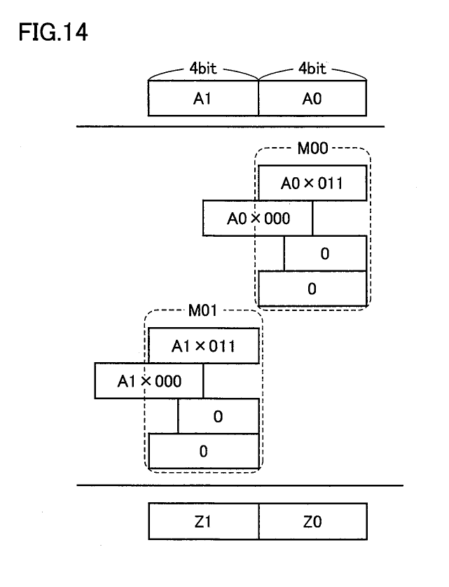

FIG. 14 represents a 1-bit shift processing flow of A that is 8 bits, performed by the semiconductor device according to the first embodiment.

In 1-bit shift processing, the operation is carried out by the inputs of X=A, Y=0001, F2=1, and SRAMIN=0.

Referring to FIG. 14, A stands for the value prior to shift processing, A0 the lower 4 bits of A, and A1 the higher 4 bits of A. Ya stands for the lower 2 bits of Y+the value of F2 register, and Yb stands for the value of the higher 3 bits of Y. Z stands for the shift processing result.

The operational processing flow will be described hereinafter.

1. Ya=011, Yb=000 are input, followed by decoding in accordance with Booth's algorithm to set the F2 flag to 1.

2. Ya=011, Yb=000 are input, followed by decoding in accordance with Booth's algorithm to set the flag.

3. X=A0, SRAMIN=0 are input. As the calculation result of A0×Ya, data corresponding to A0 shifted by 1 bit is output.

4. The most significant bit of A0 is stored in the carry register, and the lower 3 bits of A0 and 0 are output as Z0.

5. X=A1, SRAMIN=0 are input. As the calculation result of A1×Ya, data corresponding to A1 shifted by 1 bit is output.

6. The lower 3 bits of A1 and the most significant bit of A0 are output as Z1.

By repeating the processing of 1-6 set forth above, 1-bit shift processing can be performed sequentially.

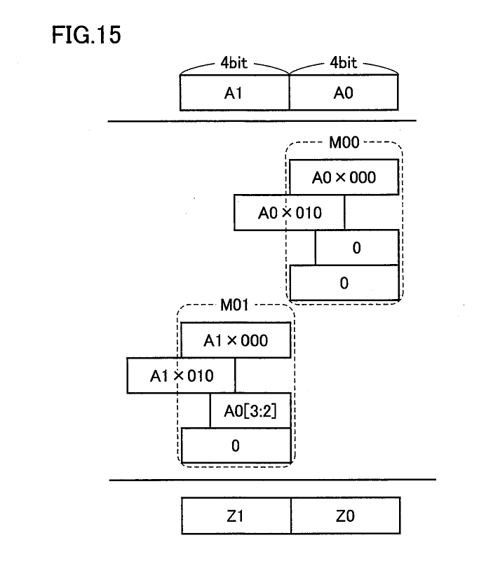

FIG. 15 represents a 2-bit shift processing flow of A that is 8 bits, performed by the semiconductor device according to the first embodiment.

In 2-bit shift processing, the operation is carried out by the inputs of X=A, Y=0100, F2=0, and SRAMIN=0.

Referring to FIG. 15, A stands for the value prior to shift processing, A0 the lower 4 bits of A, and A1 the higher 4 bits of A. Ya stands for the lower 2 bits of Y+the value of F2 register, and Yb stands for the value of the higher 3 bits of Y. Z stands for the shift processing result.

The operational processing flow will be described hereinafter.

1. Ya=000, Yb=010 are input, followed by decoding in accordance with Booth's algorithm to set the F2 flag to 0.

2. Ya=000, Yb=010 are input, followed by decoding in accordance with Booth's algorithm to set the flag.

3. X=A0, SRAMIN=0 are input. As the calculation result of A0×Ya, data corresponding to A0 shifted by 2 bits is output.

4. The higher 2 bits of A0 is stored in the carry register, and the lower 2 bits of A0 and 0 are output as Z0.

5. X=A1, SRAMIN=0 are input. As the calculation result of A1×Ya, data corresponding to A1 shifted by 2 bits is output.

6. The lower 2 bits of A1 and the higher 2 bits of A0 are output as Z1.

By repeating the processing of 1-6 set forth above, 2-bit shift processing can be performed sequentially.

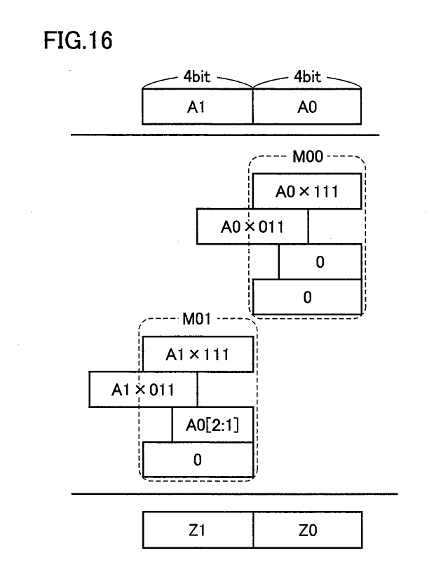

FIG. 16 represents a 3-bit shift processing flow of A that is 8 bits, performed by the semiconductor device according to the first embodiment.

In 3-bit shift processing, the operation is carried out by the inputs of X=A, Y=0111, F2=1, and SRAMIN=0.

Referring to FIG. 16, A stands for the value prior to shift processing, A0 the lower 4 bits of A, and A1 the higher 4 bits of A. Ya stands for the lower 2 bits of Y+the value of F2 register, and Yb stands for the value of the higher 3 bits of Y. Z stands for the shift processing result.

The operational processing flow will be described hereinafter.

1. Ya=111, Yb=011 are input, followed by decoding in accordance with Booth's algorithm to set the F2 flag to 1.

2. Ya=111, Yb=011 are input, followed by decoding in accordance with Booth's algorithm to set the flag.

3. X=A0, SRAMIN=0 are input. As the calculation result of A0×Ya, 0000 is output. As the calculation result of A0×Yb, data corresponding to A0 shifted by 3 bits is output.

4. The higher 3 bits of A0 are stored in the carry register, and the lower 1 bit of A0 and 000 are output as Z0.

5. X=A1, SRAMIN=0 are input. As the calculation result of A1×Ya, 0000 is output. As the calculation result of A1×Yb, data corresponding to A1 shifted by 3 bits is output.

6. The lower 1 bit of A1 and the higher 3 bits of A0 are output as Z1.

By repeating the processing of 1-6 set forth above, 3-bit shift processing can be performed sequentially.

Thus, the semiconductor device according to the first embodiment of the present invention can carry out addition, subtraction, complement, inversion, and shift processing, as well as multiplication. All these operations can be carried out at high speed.

Another embodiment of the present invention will be described hereinafter with reference to the drawings. In the drawings, the same or corresponding elements have the same reference characters allotted, and description thereof will not be repeated.

### Second Embodiment

The second embodiment relates to a semiconductor device having the operation method modified as compared to the semiconductor device according to the first embodiment. The semiconductor device of the second embodiment is similar to the semiconductor device of the first embodiment except for the features set forth below.

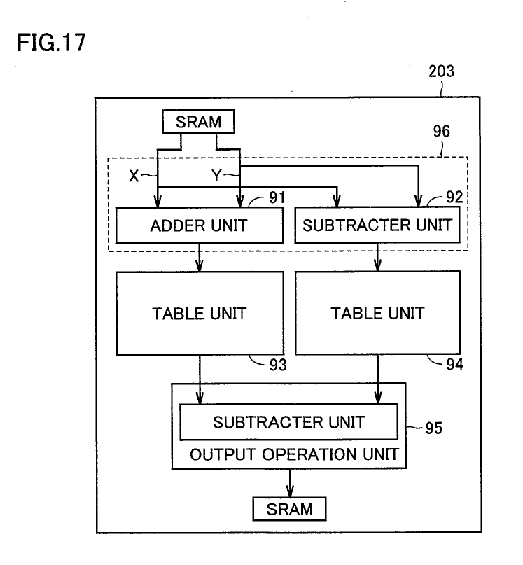

Referring to FIG. 17, a semiconductor device 203 of the second embodiment includes an adder and subtracter unit 96, table units 93 and 94, and an output operation unit 95. Adder and subtracter unit 96 includes an adder unit 91 and a subtracter unit 92.

Semiconductor device 203 calculates the product of data X and data Y. Semiconductor device 203 employs a modification of the multiplication expression and table lookup in the method constituting a bit-serial multiplier.

The multiplication algorithm employing table reference in semiconductor device 203 will be described first. In the multiplication of n bits×n bits, multiplication can be performed by referring to the table once by calculating in advance all the multiplication results and storing all the multiplication results in a table.

However, this method is disadvantageous in that the table size becomes as large as 2²ⁿ×2×n bits.

In this context, semiconductor device 203 takes advantage of the work out of equation (1) or equation (2).

X×Y=((X+Y)²−X²−Y²)/2 (1)

X×Y=((X+Y)²−(X−Y)²)/4 (2)

By calculating in advance the square of the data of (n+1) bits and storing the calculated results in a table, the multiplication of X and Y can be realized by referring to the table two times and carrying out addition−subtraction three times according to equation (1). Further, the multiplication of X and Y can be realized by referring to the table three times and carrying out addition—subtraction three times according to equation (2). In addition, the table size can be reduced to substantially 2ⁿ⁺¹×(2×n+2) bits.

Furthermore, semiconductor device 203 performs the multiplication of X and Y according to equations (3) and (4) set forth below under the condition of X≧Y.

When X+Y take an even number, X×Y=((X+Y)/2)²−((X−Y)/2)² (3)

When X+Y take an odd number, X×Y=((X+Y−1)/2)²−((X−Y−1)/2)²+Y (4)

When X+Y take an even number, X−Y also will always take an even number. Further, the least significant bit of (X+Y) and (X−Y) will always be 0, when represented in binary notation. In other words, there will be no remainder in the calculation of ((X+Y)/2) and the calculation of ((X−Y)/2), and the calculation result will always be less than or equal to n bits. Therefore, in the execution of equation (3), a table for an operation of n² bits, i.e. n bits×n bits, is to be provided. The table size can be further reduced to 2ⁿ×2×n bits from 2ⁿ⁺¹×(2×n+2) bits.

When X+Y take an odd number, X−Y also will always take an odd number. Further, the least significant bit of (X+Y) and (X−Y) will always be 1, when represented in binary notation. Namely, when X+Y take an odd number, the least significant bit will always become 0 by subtracting 1 from each of (X+Y) and (X−Y). Accordingly, there will be no remainder in the calculation of ((X+Y−1)/2) and the calculation of ((X−Y−1)/2). The calculated result will always be less than or equal to n bits. Therefore, in the execution of equation (4), a table for an operation of n² bits, i.e. n bits×n bits, is to be provided. The table size can be further reduced to 2ⁿ×2×n bits from 2ⁿ⁺¹×(2×n+2) bits.

The operation of each functional block in semiconductor device 203 realizing the algorithm set forth above will be described hereinafter. First, the operation of semiconductor device 203 when X+Y take an even number will be described hereinafter.

Adder unit 91 adds data X and data Y to provide the sum data corresponding to the added result to table unit 93.

Subtracter unit 92 obtains the difference between data X and data Y to provide the difference data corresponding to subtracted result to table unit 94.

Table unit 93 converts the sum data received from adder unit 91 into first square data for output. The first square data is obtained by dividing the sum data by 2 and raising the divided result to the second power.

Table unit 94 converts the difference data received from subtracter unit 92 into second square data for output. The second square data is obtained by dividing the difference data by 2 and raising the divided result to the second power.

The subtracter unit in output operation unit 95 obtains the difference between the first square data from table unit 93 and the second square data from table unit 94. The subtraction result is output as the multiplication result of data X and data Y.

Output operation unit 95 adds the multiplication result calculated at the subtracter unit with the accumulated value up to the multiplication result of the preceding stage in the serial multiplication, received from the SRAM. The data indicating the addition result is stored in the SRAM. Semiconductor device 203 may be configured to include an SRAM.

The operation of semiconductor device 203 when X+Y take an odd number will be described hereinafter.

Adder unit 91 adds data X and data Y, and subtracts 1 from the addition result. This sum data is output to table unit 93.

Subtracter unit 92 obtains the difference between data X and data Y, and subtracts 1 from the division result. This difference data is output to table unit 94.

Table unit 93 converts the sum data received from adder unit 91 into first square data for output. The first square data is obtained by dividing the sum data by 2 and raising the divided result to the second power.

Table unit 94 converts the difference data received from subtracter unit 92 into second square data for output. The second square data is obtained by dividing the difference data by 2 and raising the divided result to the second power.

The subtracter in output operation unit 95 obtains the difference between the first square data from table unit 93 and the second square data from table unit 94 to output the subtraction result as the multiplication result of data X and data Y.

Output operation unit 95 adds the multiplication result calculated at the subtracter unit with the accumulated value up to the multiplication result of the preceding stage in serial multiplication, received from the SRAM, and stores data indicating the addition result in the SRAM.

The following description is provided on the assumption that data X and data Y each are data of 4 bits. Namely, in data Y0-Y3 and data X0-X3, data with a smaller number represents a lower order bit. The LSB is data Y0 and data X0. The MSB is data Y3 and data X3. Each of data X0-X3 may also be referred generically as data X. Each of data Y0-Y3 may also be referred generically as data Y.

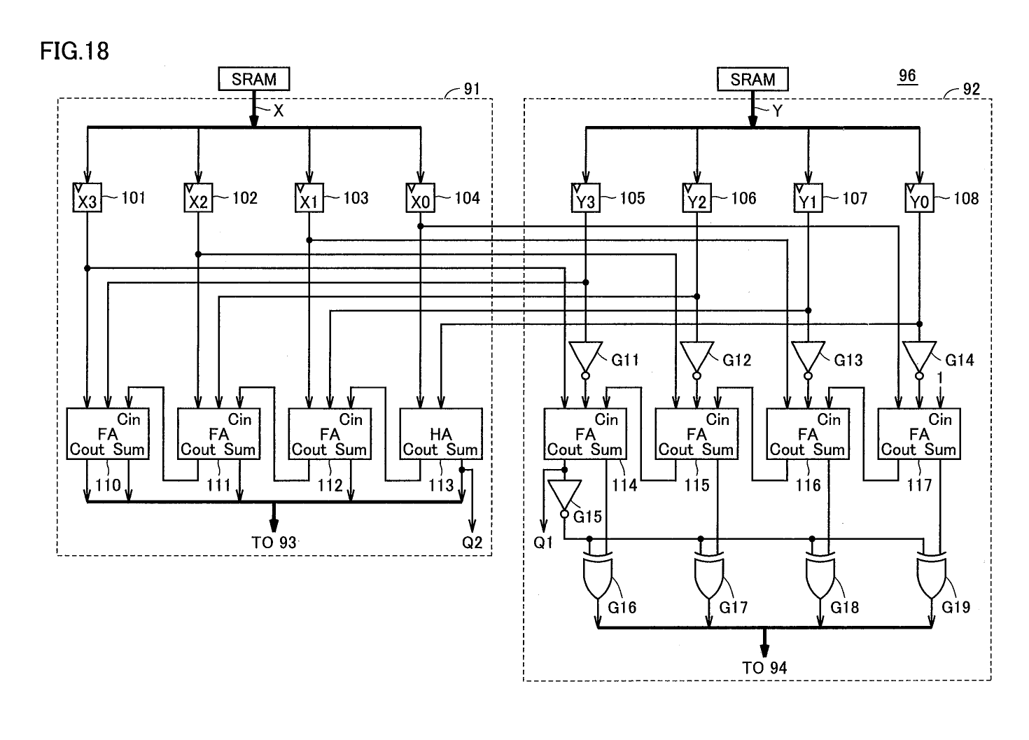

FIG. 18 represents a configuration of an adder and subtracter unit in the semiconductor device according to the second embodiment of the present invention. FIG. 18 corresponds to a configuration when X+Y take an even number.

Referring to FIG. 18, adder unit 91 includes registers 101-104, full adders 110-112, and a half adder 113. Subtracter unit 92 includes registers 105-108, full adders 114-117, a NOT gate G15, and EXOR gates G16-G19.

Register 101 retains and outputs to full adders 110 and 114 data X3 received from the SRAM. Register 102 retains and outputs to full adders 111 and 115 data X2 received from the SRAM. Register 103 retains and outputs to full adders 112 and 116 data X1 received from the SRAM. Register 104 retains and outputs to half adder 113 and full adder 117 data X0 received from the SRAM.

Register 105 retains and outputs to full adder 110 and NOT circuit G11 data Y3 received from the SRAM. Register 106 retains and outputs to full adder 111 and NOT circuit G12 data Y2 received from the SRAM. Register 107 retains and outputs to full adder 112 and NOT circuit G13 data Y1 received from the SRAM. Register 108 retains and outputs to half adder 113 and NOT circuit G14 data Y0 received from the SRAM. NOT gates G11-G14 invert the logic level of the data received from registers 105-108, respectively, and output the inverted data to full adders 114-117.

Full adder 110 receives carry output Cout from full adder 111 as carry input Cin, i.e. the shift-up value, and adds the same with data X3 received from register 101 and data Y3 received from register 105 to output the lower order bit of the addition result to table unit 93 as data Sum and to output the higher order bit of the addition result, i.e. the shift-up value, to table unit 93 as carry output Cout.

Full adder 111 receives carry output Cout from full adder 112 as carry input Cin, i.e. the shift-up value, and adds the same with data X2 received from register 102 and data Y2 received from register 106 to output the lower order bit of the addition result to table unit 93 as data Sum and to output the higher order bit of the addition result, i.e. the shift-up value, to full adder 110 as carry output Cout.

Full adder 112 receives carry output Cout from half adder 113 as carry input Cin, i.e. the shift-up value, and adds the same with data X1 received from register 103 and data Y1 received from register 107 to output the lower order bit of the addition result to table unit 93 as data Sum and to output the higher order bit of the addition result, i.e. the shift-up value, to full adder 111 as carry output Cout.

Half adder 113 adds data X0 received from register 104 and data Y0 received from register 108 to output the lower order bit of the addition result to table unit 93 as data Sum, and to output the higher order bit of the addition result, i.e. the shift-up value, to full adder 112 as carry output Cout.

Full adder 114 receives carry output Cout from full adder 115 as carry input Cin, i.e. the shift-up value, and adds the same with data X3 received from register 101 and the inverted data of data Y3 received from NOT gate G11 to output the lower order bit of the addition result to EXOR gate G16 as data Sum and to output the higher order bit of the addition result, i.e. the shift-up value, to NOT gate G15 as carry output Cout. NOT gate G15 inverts the logic level of carry output Cout from full adder 114, and outputs the inverted data to EXOR gates G16-G19.

Full adder 115 receives carry output Cout from full adder 116 as carry input Cin, i.e. the shift-up value, and adds the same with data X2 received from register 102 and the inverted data of data Y2 received from NOT gate G12 to output the lower order bit of the addition result to EXOR gate G17 as data Sum and to output the higher order bit of the addition result, i.e. the shift-up value, to full adder 114 as carry output Cout.

Full adder 116 receives carry output Cout from full adder 117 as carry input Cin, i.e. the shift-up value, and adds the same with data X1 received from register 103 and the inverted data of data Y1 received from NOT gate G13 to output the lower order bit of the addition result to EXOR gate G18 as data Sum and to output the higher order bit of the addition result, i.e. the shift-up value, to full adder 115 as carry output Cout.

Full adder 117 receives data indicating 1 as carry input Cin, i.e. the shift-up value, and adds the same with data X0 received from register 104 and the inverted data of data Y0 from NOT gate G14 to output the lower order bit of the addition result to EXOR gate G19 as data Sum, and to output the higher order bit of the addition result, i.e. the shift-up value, to full adder 116 as carry output Cout.

EXOR gates G16-G19 output to table unit 94 the exclusive OR of data Sum received from full adders 114-117, respectively, and the data from NOT gate G15.

Adder unit 91 is formed of four adders. Subtracter unit 92 carries out the operation of X−Y by adding the complement of Y to X, i.e. adding inverted Y to 1 and X.

Adder unit 91 outputs a positive value when X≧Y. Further, overflow occurs at adder unit 91. Adder unit 91 outputs the complement value when X<Y.

Although the sign will not become a problem when the calculated result of X−Y is directly raised to the second power, the complement of the output result is taken when X<Y, since table unit 94 implements table reference in semiconductor device 203. Namely, since determination can be made that X<Y when overflow does not occur, data of the logical high level is output from NOT circuit G15 to EXOR gates G16-G19 when carry output Cout of full adder 114 is 0. Accordingly, EXOR gates G16-19 invert data Sum received from full adders 114-117 for output.

The operation of the table units will be described hereinafter. Semiconductor device 203 utilizes a table converting into data obtained by raising the added value of data X of n bits and data Y of n bits to the second power, and converting into data obtained by raising the subtracted value between data X of n bits and data Y of n bits to the second power. Although the data of X+Y squared becomes n+1 bits at most and the data of X−Y squared becomes n bits at most, it is to be noted that these data squared will be set to ¼ times subsequently. Therefore, data that requires table reference is n bits for X+Y and n−1 bits for X−Y.

In table unit 93, the calculated result of ((X+Y)/2)² is stored. In table unit 94, the calculated result of ((X−Y)/2)² is stored.

With regards to the table unit, it is possible to prepare a common table to be shared for the addition result and subtraction result, or prepare individual tables when addition and subtraction are to be executed at the same time.

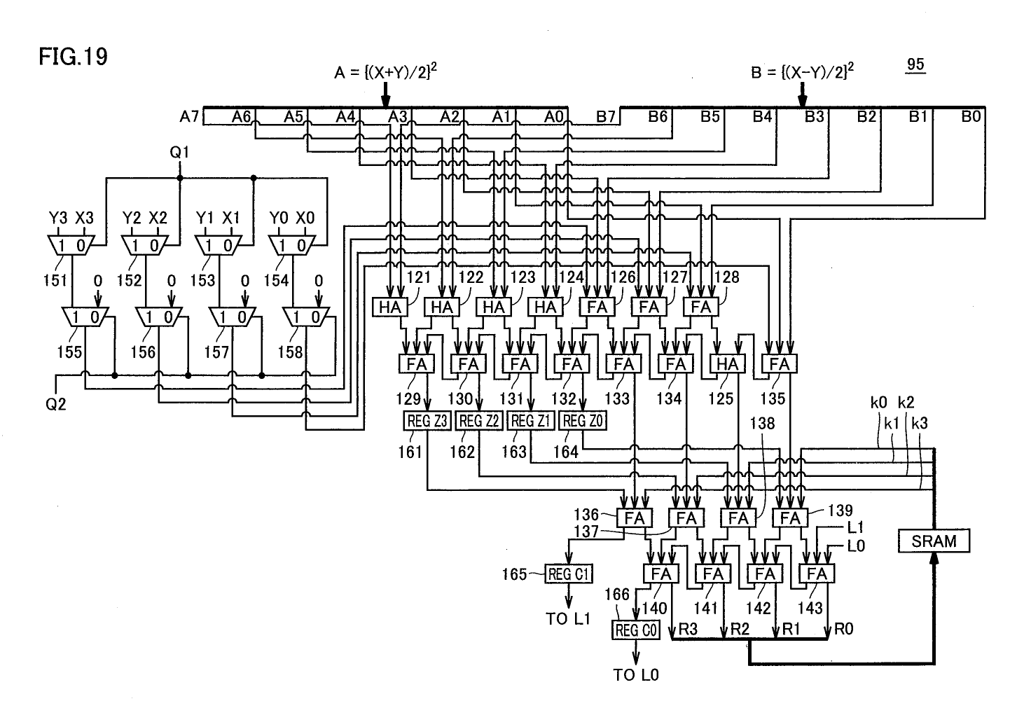

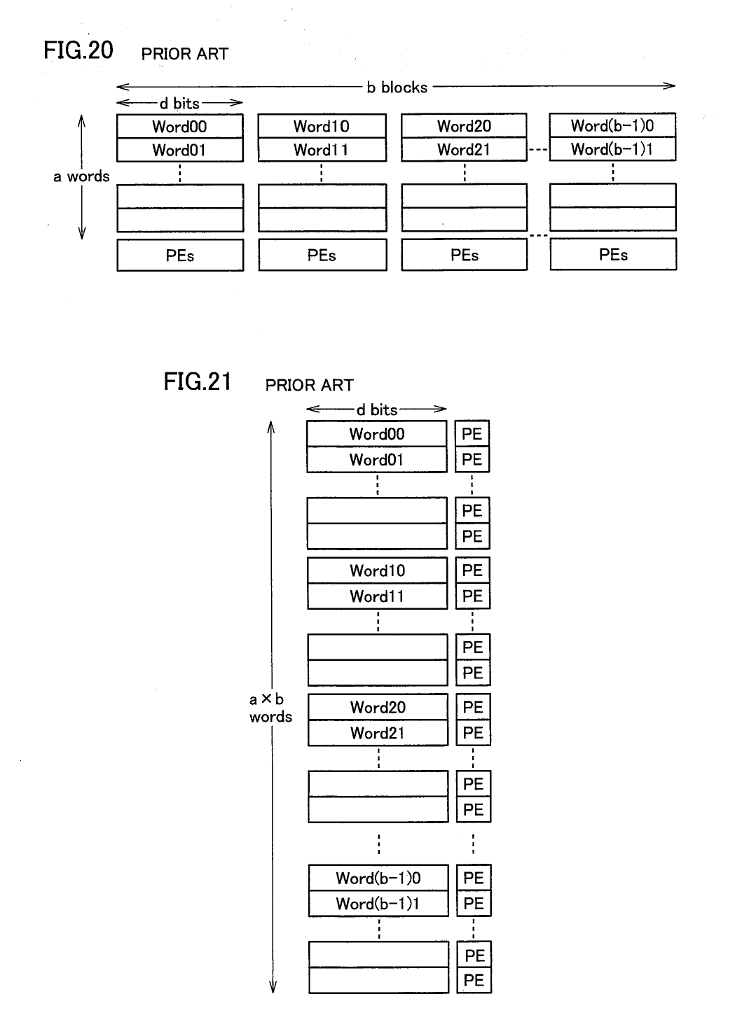

FIG. 19 represents a configuration of output operation unit 95 in the semiconductor device according to the second embodiment of the present invention. FIG. 19 represents a configuration in which individual tables are prepared for the addition result and subtraction result. In data A0-A7 indicating output data of table unit 93, data B0-B7 indicating the output data of table unit 94, and accumulated partial products K0-K3 of FIG. 19, data of a smaller number represents the lower order bit. The LSB is data A0, data B0, and accumulated partial product K0. The MSB is data A7, data B7, and accumulated partial product K3. Each of data A0-A7 may also be referred generically as data A. Each of data B0-B7 may also be referred generically as data B. Each of accumulated partial products K0-K3 may also be referred generically as accumulated partial product K. As used herein, accumulated partial products K0-K3 are the accumulated value up to the multiplication result of the preceding stage in serial multiplication, stored in the SRAM.

When individual tables are to be prepared for the addition result and subtraction result, the table for the subtraction result takes the size of 2ⁿ⁻¹×(2×n−2) bits. In this case, by setting the values in the table for the subtraction results as values taking the complement of (X−Y)², the calculation in output operation unit 95 can be reduced to only addition.

Referring to FIG. 19, output operation unit 95 includes half adders 121-125, full adders 126-143, multiplexers 151-158, and registers 161-166.

In the conversion processing of table units 93 and 94, the numeral (X+Y)/2 is handled. When X+Y take an odd number, (X+Y)/2 will no longer be an integer. Therefore, either X or Y must further be added to the subtraction result between data A and data B. To this end, output operation unit 95 uses multiplexers 151-158 to determine whether X or Y is to be added based on the least significant bit Q2 of X+Y, i.e. data Sum output from half adder 113 of adder unit 91 shown in FIG. 18, and then determines which of X and Y is to be added based on the magnitude relationship between X and Y.

Specifically, data Q1 takes 1 when X>Y, and 0 when X≦Y. Data Q1 is carry output Cout provided from full adder 114 of subtracter unit 92 shown in FIG. 18, for example.

Multiplexer 151 selects and outputs to multiplexer 155 data Y3 when data Q1 is 1, and data X3 when data Q1 is 0. Multiplexer 152 selects and outputs to multiplexer 156 data Y2 when data Q1 is 1 and data X2 when data Q1 is 0. Multiplexer 153 selects and outputs to multiplexer 157 data Y1 when data Q1 is 1 and data X1 when data Q1 is 0. Multiplexer 154 selects and outputs to multiplexer 158 data Y0 when data Q1 is 1 and data X0 when data Q1 is 0.

Multiplexer 155 selects and outputs to full adder 126 the data received from multiplexer 151 and the data 0 when the least significant bit Q2 of the data indicating the calculation result of (X+Y) is 1 and 0, respectively.

Multiplexer 156 selects and outputs to full adder 127 the data received from multiplexer 152 and the data 0 when the least significant bit Q2 of the data indicating the calculation result of (X+Y) is 1 and 0, respectively.

Multiplexer 157 selects and outputs to full adder 128 the data received from multiplexer 153 and the data 0 when the least significant bit Q2 of the data indicating the calculation result of (X+Y) is 1 and 0, respectively.

Multiplexer 158 selects and outputs to full adder 135 the data received from multiplexer 154 and the data 0 when the least significant bit Q2 of the data indicating the calculation result of (X+Y) is 1 and 0, respectively.

Half adder 121 adds data A7 and data B7 to output the lower order bit of the addition result to full adder 129 as data Sum.

Half adder 122 adds data A6 and data B6 to output the lower order bit of the addition result to full adder 130 as data Sum, and to output the higher order bit of the addition result, i.e. the shift-up value, to full adder 129 as carry output Cout.

Half adder 123 adds data A5 and data B5 to output the lower order bit of the addition result to full adder 131 as data Sum, and to output the higher order bit of the addition result, i.e. the shift-up value, to full adder 130 as carry output Cout.

Half adder 124 adds data A4 and data B4 to output the lower order bit of the addition result to full adder 132 as data Sum, and to output the higher order bit of the addition result, i.e. the shift-up value, to full adder 131 as carry output Cout.

Full adder 126 receives data B3 as carry input Cin, i.e. the shift-up value, and adds the same with the data received from multiplexer 155 and data A3 to output the lower order bit of the addition result to full adder 133 as data Sum, and to output the higher order bit of the addition result, i.e. the shift-up value, to full adder 132 as carry output Cout.

Full adder 127 receives data B2 as carry input Cin, i.e. the shift-up value, and adds the same with the data received from multiplexer 156 and data A2 to output the lower order bit of the addition result to full adder 134 as data Sum, and to output the higher order bit of the addition result, i.e. the shift-up value, to full adder 133 as carry output Cout.

Full adder 128 receives data B1 as carry input Cin, i.e. the shift-up value, and adds the same with the data received from multiplexer 157 and data A1 to output the lower order bit of the addition result to half adder 125 as data Sum, and to output the higher order bit of the addition result, i.e. the shift-up value, to full adder 134 as carry output Cout.

Full adder 129 receives carry output Cout from full adder 130 as carry input Cin, i.e. the shift-up value, and adds the same with data Sum received from half adder 121 and carry output Cout received from half adder 122 to output the lower order bit of the addition result to register 161 as data Sum.

Full adder 130 receives carry output Cout from full adder 131 as carry input Cin, i.e. the shift-up value, and adds the same with data Sum received from half adder 122 and carry output Cout received from half adder 123 to output the lower order bit of the addition result to register 162 as data Sum, and to output the higher order bit of the addition result, i.e. the shift-up value, to full adder 129 as carry output Cout.

Full adder 131 receives carry output Cout from full adder 132 as carry input Cin, i.e. the shift-up value, and adds the same with data Sum received from half adder 123 and carry output Cout received from half adder 124 to output the lower order bit of the addition result to register 163 as data Sum, and to output the higher order bit of the addition result, i.e. the shift-up value, to full adder 130 as carry output Cout.

Full adder 132 receives carry output Cout from full adder 133 as carry input Cin, i.e. the shift-up value, and adds the same with data Sum received from half adder 124 and carry output Cout received from full adder 126 to output the lower order bit of the addition result to register 164 as data Sum, and to output the higher order bit of the addition result, i.e. the shift-up value, to full adder 131 as carry output Cout.

Full adder 133 receives carry output Cout from full adder 134 as carry input Cin, i.e. the shift-up value, and adds the same with data Sum received from full adder 126 and carry output Cout received from full adder 127 to output the lower order bit of the addition result to full adder 136 as data Sum, and to output the higher order bit of the addition result, i.e. the shift-up value, to full adder 132 as carry output Cout.

Full adder 134 receives carry output Cout from half adder 125 as carry input Cin, i.e. the shift-up value, and adds the same with data Sum received from full adder 127 and carry output Cout received from full adder 128 to output the lower order bit of the addition result to full adder 137 as data Sum, and to output the higher order bit of the addition result, i.e. the shift-up value, to full adder 133 as carry output Cout.

Half adder 125 adds data Sum received from full adder 128 and carry output Cout received from full adder 135 to output the lower order bit of the addition result to full adder 138 as data Sum, and to output the higher order bit of the addition result, i.e. the shift-up value, to full adder 134 as carry output Cout.

Full adder 135 receives data B0 as carry input Cin, i.e. the shift-up value, and adds the same with the data received from multiplexer 158 and data A0 to output the lower order bit of the addition result to full adder 139 as data Sum, and to output the higher order bit of the addition result, i.e. the shift-up value, to half adder 125 as carry output Cout.

Registers 161-164 retain and output to full adders 136-139 data Sum received from full adders 129-132, respectively. It is to be noted that the operation bit width of output operation unit 95 is only 4 bits, whereas the data length of each of data A and data B is 8 bits. The provision of registers 161-164 allows the data of the higher order side to be temporarily saved for execution of the calculation split into two operations. Full adder 136 receives accumulated partial product K3 received from the

SRAM as carry input Cin, i.e. the shift-up value, and adds the same with data Sum received from full adder 133 and the data received from register 161 to output the lower order bit of the addition result to full adder 140 as data Sum, and to output the higher order bit of the addition result, i.e. the shift-up value, to register 165 as carry output Cout.

Full adder 137 receives accumulated partial product K2 from the SRAM as carry input Cin, i.e. the shift-up value, and adds the same with data Sum received from full adder 134 and the data received from register 162 to output the lower order bit of the addition result to full adder 141 as data Sum, and to output the higher order bit of the addition result, i.e. the shift-up value, to full adder 140 as carry output Cout.

Full adder 138 receives accumulated partial product K1 from the SRAM as carry input Cin, i.e. the shift-up value, and adds the same with data Sum received from half adder 125 and the data received from register 163 to output the lower order bit of the addition result to full adder 142 as data Sum, and to output the higher order bit of the addition result, i.e. the shift-up value, to full adder 141 as carry output Cout.

Full adder 139 receives accumulated partial product K0 from the SRAM as carry input Cin, i.e. the shift-up value, and adds the same with data Sum received from full adder 135 and the data received from register 164 to output the lower order bit of the addition result to full adder 143 as data Sum, and to output the higher order bit of the addition result, i.e. the shift-up value, to full adder 142 as carry output Cout.

Full adder 140 receives data Sum from the full adder 141 as carry input Cin, i.e. the shift-up value, and adds the same with data Sum received from full adder 136 and carry output Cout received from full adder 137 to output the lower order bit of the addition result as data R3, and to output the higher order bit of the addition result, i.e. the shift-up value, to register 166 as carry output Cout.

Full adder 141 receives carry output Cout from full adder 142 as carry input Cin, i.e. the shift-up value, and adds the same with data Sum received from full adder 137 and carry output Cout received from full adder 138 to output the lower order bit of the addition result as data R2, and to output the higher order bit of the addition result, i.e. the shift-up value, to full adder 140 as carry output Cout.

Full adder 142 receives carry output Cout from full adder 143 as carry input Cin, i.e. the shift-up value, and adds the same with data Sum received from full adder 138 and carry output Cout received from full adder 139 to output the lower order bit of the addition result as data R1 and to output the higher order bit of the addition result, i.e. the shift-up value, to full adder 141 as carry output Cout.

Register 165 retains carry output Cout received from full adder 136 and outputs the same to full adder 143 as data L1. Register 166 retains carry output Cout received from full adder 140, and outputs the same to full adder 143 as data L0.

Full adder 143 receives data LO from register 166 as carry input Cin, i.e. the shift-up value, and adds the same with data Sum received from full adder 139 and data L1 received from register 165 to output the lower order bit of the addition result as data R0, and to output the higher order bit of the addition result, i.e. the shift-up value, to full adder 142 as carry output Cout.

Likewise with the semiconductor device according to the first embodiment of the present invention, the semiconductor device according to the second embodiment of the present invention can have the circuit area reduced to improve the parallelism, and can perform signed multiplication at high speed. By sequentially performing serial processing, operation of a variable length is allowed. Moreover, addition and subtraction operations frequently encountered in multimedia processing can be executed. Thus, multimedia data can be processed effectively.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A semiconductor device comprising:
a first decoder receiving first multiplier data of 3 bits indicating a multiplier to output a shift flag, an inversion flag, and an operation flag in accordance with Booth's algorithm, and
a first partial product calculation unit receiving first multiplicand data of 2 bits indicating a multiplicand, said shift flag, said inversion flag, and said operation flag to select one of a higher order bit and lower order bit of said first multiplicand data based on said shift flag, invert or non-invert the selected bit based on said inversion flag, select one of said inverted or non-inverted data and data of a predetermined logic level based on said operation flag, and output the selected data as partial product data indicating a partial product of said first multiplier data and said first multiplicand data.

2. The semiconductor device according to claim 1, wherein
said first multiplicand data includes a first multiplicand bit that is the lower order bit and a second multiplicand bit that is the higher order bit, and
said first decoder receives said first multiplier data to further output a complement flag in accordance with Booth's algorithm,
said semiconductor device further comprising:
a second partial product calculation unit receiving second multiplicand data having the second multiplicand bit as a lower order bit and a third multiplicand bit as a higher order bit, said shift flag, said inversion flag, and said operation flag to select one of the higher order bit and lower order bit of said second multiplicand data based on said shift flag, invert or non-invert said selected bit based on said inversion flag, select one of said inverted or non-inverted data and data of a predetermined logic level based on said operation flag, and output the selected data as partial product data indicating the partial product of said first multiplier data and said second multiplicand data, and
a partial product adder unit executing complement processing on said partial product data received from said first partial product calculation unit and said partial product data received from said second partial product calculation unit based on said complement flag, and adding each said partial product data.

3. The semiconductor device according to claim 2, wherein said first multiplier data includes a first multiplier bit that is a least significant bit, a second multiplier bit that is a second bit, and a third multiplier bit that is a most significant bit,
said semiconductor device further comprising:
a second decoder receiving second multiplier data of 3 bits having said third multiplier bit as a least significant bit to output a shift flag, an inversion flag, an operation flag, and a complement flag in accordance with Booth's algorithm,
a third partial product calculation unit receiving said first multiplicand data, said shift flag, said inversion flag, and said operation flag from said second decoder to select one of the higher order bit and lower order bit of said first multiplicand data based on said shift flag, invert or non-invert said selected bit based on said inversion flag, select one of said inverted or non-inverted data and data of a predetermined logic level based on said operation flag, and output the selected data as partial product data indicating the partial product of said second multiplier data and said first multiplicand data,
a fourth partial product calculation unit receiving said second multiplicand data, said shift flag, said inversion flag, and said operation flag from second decoder to select one of the higher order bit and lower order bit of said second multiplicand data based on said shift flag, invert or non-invert said selected bit based on said inversion flag, select one of said inverted or non-inverted data and data of a predetermined logic level based on said operation flag, and output the selected data as partial product data indicating the partial product of said second multiplier data and said second multiplicand data, wherein
said partial product adder unit executes complement processing on said partial product data received from said first partial product calculation unit and said partial product data received from said second partial product calculation unit based on said complement flag received from said first decoder, executes complement processing on said partial product data received from said third partial product calculation unit and said partial product data received from said fourth partial product calculation unit based on said complement flag received from said second decoder, and adds each said partial product data.

4. A semiconductor device calculating a product of first data and second data, comprising:
an adder unit adding said first data and said second data to output sum data corresponding to said adding,
a subtracter unit obtaining a difference between said first data and said second data by subtracting to output difference data corresponding to said subtracting,
a first table unit converting said sum data received from said adder unit into first square data raised to a second power for output,
a second table unit converting said difference data received from said subtracter unit into second square data raised to a second power for output, and
an output operation unit obtaining a difference between said first square data received from said first table unit and said second square data received from said second table unit by subtracting to output a subtracted result as a product of said first data and said second data.

5. The semiconductor device according to claim 4, wherein
said first table unit converts said sum data received from said adder unit into said first square data for output, said first square data obtained by dividing said sum data by 2 and raising the divided result to the second power,
said second table unit converts said difference data received from said subtracter unit into said second square data for output, said second square data obtained by dividing said difference data by 2 and raising the divided result to the second power.

6. The semiconductor device according to claim 4, wherein
said adder unit adds said first data and said second data and outputs sum data corresponding to 1 subtracted from the added result,
said subtracter unit subtracts said first data from said second data and outputs difference data corresponding to 1 subtracted from the subtracted result,
said first table unit converts said sum data received from said adder unit into said first square data for output, said first square data obtained by dividing said sum data by 2 and raising the divided result to the second power,
said second table unit converts said difference data received from said subtracter unit into said second square data for output, said second square data obtained by dividing said difference data by 2 and raising the divided result to the second power, and
said output operation unit obtains a difference between said first square data received from said first table unit and said second square data received from said second table unit by subtracting, and outputs data corresponding to an addition of the subtracted result and said first data as a product of said first data and said second data.
